(19) United States
(12) Patent Application Publication
(10) Pub. No.: US 2020/0309666 A1
(43) Pub. Date: Oct. 1, 2020

(54) DETECTION OF FLUID PARTICLE CONCENTRATIONS

(71) Applicant: Hewlett-Packard Development Company, L.P., Spring, TX (US)

(72) Inventors: Eric Martin, Corvallis, OR (US); James Michael Gardner, Corvallis, OR (US); James A. Feinn, San Diego, CA (US); Rogelio Cicili, San Diego, CA (US)

(73) Assignee: Hewlett-Packard Development Company, L.P., Spring, TX (US)

(21) Appl. No.: 16/760,933

(22) PCT Filed: Dec. 11, 2017
(86) PCT No.: PCT/US2017/065543

§ 371 Date: May 1, 2020

(51) Int. Cl. G01N 15/06; B41J 2/14; G01N 27/07

(52) U.S. Cl. CPC G01N 15/0656; G01N 2015/0053; G01N 27/07; B41J 2/14153

(57) ABSTRACT

A fluid particle concentration detection device may include at least one electrode disposed within a fluidic passageway of a fluidic die, and control circuitry to activate the electrode within the fluidic die. An impedance sensed at the electrode corresponds to a particle concentration within the fluid.

### BACKGROUND

A fluidic die may be used to move fluids within the fluidic die, eject fluids onto media, or combinations thereof. The fluids within a fluidic die may include any fluid that may be moved within or ejected from the fluidic die. For example, the fluids may include inks, dyes, chemical pharmaceuticals, biological fluids, gases, and other fluids. The fluids may be used to print images on media or effectuate chemical reactions between different fluids, for example. Further, in additive manufacturing processes such as those that use a three-dimensional (3D) printing device, the fluidic die may eject build materials, adhesives, and other fluids that may be used to build a 3D object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1A is a block diagram of a fluid particle concentration detection device including an electrode used in fluid particle concentration detection, according to an example of the principles described herein.

FIG. 1B is a block diagram of a portion of a fluidic die including an electrode used in fluid particle concentration detection, according to another example of the principles described herein.

FIG. 2 is a flowchart showing a method of detecting fluid particle concentration, according to an example of the principles described herein.

FIG. 3 is a flowchart showing a method of detecting fluid particle concentration, according to another example of the principles described herein.

FIG. 4 depicts a number of graphs depicting the concentration of particles, forced electrode current, and electrode voltage over time, according to an example of the principles described herein.

FIG. 5 is a block diagram of a fluidic device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Some fluids moved within and/or ejected from a fluidic die may include a fluid vehicle and particles where the fluid vehicle is used to carry or suspend a particle within the fluid vehicle. These types of fluids may include, for example, a printing fluid that includes color pigments suspended in an ink vehicle. Printing systems such as inkjet printers include printheads, and the printheads include firing chambers including nozzle regions having printing fluid therein, and fluid ejectors to eject the printing fluid in the nozzle regions onto media. Over time, the color pigments in the ink vehicle located in the nozzle region may diffuse and move away from the nozzle region resulting in pigment ink vehicle separation. The separation of the pigment particles from the ink vehicle may be referred to herein as pigment ink vehicle separation or pigment vehicle separation (PIVS), or may be generically referred to herein as particle vehicle separation (PVS).

PVS may occur when a particle-containing fluid sits in a portion of the fluidic die a period of, for example, seconds or minutes without being refreshed. Due to evaporation through a nozzle, and other effects related to the fluid formulation, particles within the fluid may, over time, migrate out of a first portion of the fluidic die such as a fluid ejection chamber, and back into other fluid containing portions of the fluidic die such as a slot or shelf area. When PVS occurs, this leaves fluid in the chamber without its particle constituent. If, in the case of a pigmented ink, the pigmented ink is ejected from a nozzle in a PVS condition, a first number of ejected drops out of the nozzle will not have a correct amount or concentration of pigment particles or colorant in it, and will affect the print quality of that part of the printed image. Stated another way, as a consequence of PIVS for example, ejection of the printing fluid in the nozzle region with a reduced amount of color pigments onto the media results in a reduction of image quality due to the relatively lower concentration of pigment particles in the printing fluid that do not get ejected onto the media. A resulting print on the media in a PIVS situation may have a perceivable deficiency in vibrant colors and may look discolored, faded, dull, or pale. In situations where a feature with many drops is to be printed, the act of ejecting fluid from the fluidic die will refresh the nozzles, and any defects will present on the leading edge of the printed feature such as the first few or several drops of fluid out of the fluidic die. However, if the printed feature is a narrow line including, for example, a few drops in total, the entirety of the line may be missing pigment and thus appear invisible on the printed media.

Additionally, at times, pigment ink vehicle separation may result in solidification of the printing fluid in the nozzle region. Particle interaction in a PVS scenario may cause a spectrum of responses based on characteristics of the particles and the environment in which the fluid exists, including, for example, the geometry of the particles and the design of the chambers within the fluidic die, among other characteristics. In this case, the respective nozzle region may prevent the ejection of printing fluid and reduce the lifespan of a corresponding fluid ejector.

Even though pigment inks are used herein as an example to describe a fluid vehicle and particles where the fluid vehicle is used to carry or suspend a particle within the fluid vehicle, similar fluids including particles and a fluid vehicle may be equally applicable. For example, some biological fluids such as blood may include particles suspended in a fluid vehicle. In the case of blood, blood includes bloods cells suspended in blood plasma. In this example, the blood cells may separate or diffuse where a higher concentration of blood cells exist in a first portion of the blood plasma relative to another portion of the blood plasma where there may exist a relatively lower concentration of blood cells.

Therefore, PVS may occur in a wide range of fluids that are moved within and/or ejected from a fluidic die. Detection of the separation of a particle from its fluid vehicle may allow for remedial measures to be taken to correct any particle concentration disparities within the fluid. Thus, examples described herein provide a fluid particle concentration detection device that may include at least one electrode disposed within a fluidic passageway of a fluidic die, and control circuitry to activate the electrode within the fluidic die. An impedance sensed at the electrode corresponds to a particle concentration within the fluid. The fluidic passageway may be a fluid ejection chamber. The fluidic passageway may be a fluid channel. The fluidic die may be a fluid ejection die. An impedance sensed by the electrode correlates with the particle concentration within the fluid.

Examples described herein also provide a fluidic ejection device. The fluid ejection device may include a fluid reservoir for storing a volume of fluid, a fluidic die fluidically coupled to the fluid reservoir, an electrode disposed within a fluidic passageway of the fluidic die, and control circuitry to activate the electrode within the fluidic die. An impedance sensed at the electrode is proportional to a dispersion level of a solid within a fluid vehicle of the fluid. The fluidic passageway may be a fluid ejection chamber. The fluidic passageway may be a fluid channel.

The voltage sensed at the electrode corresponds to an impedance of the fluid. A relatively lower impedance corresponds to a higher particle concentration within the fluid, and a relatively higher impedance corresponds to a lower particle concentration within the fluid. In some examples, a relatively lower impedance corresponds to a lower particle concentration within the fluid, and a relatively higher impedance corresponds to a higher particle concentration within the fluid.

Examples described herein also provide a method of detecting fluid particle concentration. The method may include providing a current to an electrode disposed within a fluidic passageway of a fluidic die, the current being forced into a fluid within the fluidic die, sensing a voltage at the electrode; and determining a fluid particle concentration level of the fluid based on the sensed voltage. In one example, a voltage may be provided to the electrode, and current may be sensed to determine the fluid particle concentration level of the fluid based on the sensed current. The fluid particle concentration level of the fluid may correspond to by an impedance value based on the sensed voltage. A relatively lower impedance corresponds to a higher particle concentration within the fluid, and a relatively higher impedance corresponds to a lower particle concentration within the fluid.

The method may further include determining if the fluid particle concentration level is below a threshold, and in response to a determination that the fluid particle concentration level is below the threshold, performing at least one remedial process to increase the fluid particle concentration level. In response to a determination that the fluid particle concentration level is above the threshold, performing a fluid ejection process. The method may be performed during a quiescent period of the fluidic die. The at least one remedial process may include a micro-recirculation of the fluid within the fluidic passageway, a macro-recirculation of the fluid within the fluidic passageway, a spitting operation, an adjustment of a backpressure of the fluid to pull a meniscus of the fluid into the fluidic passageway, a wiping an orifice plate of the fluidic die, or combinations thereof.

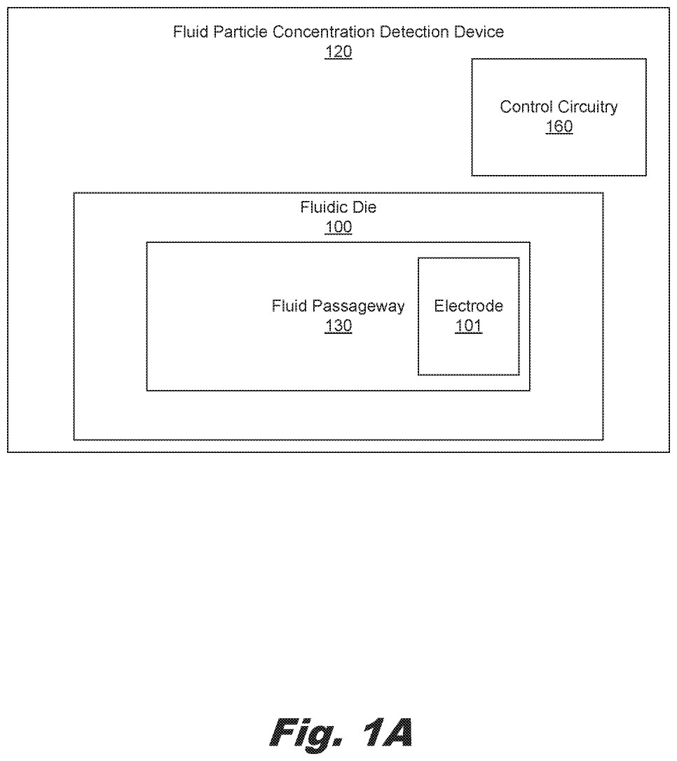

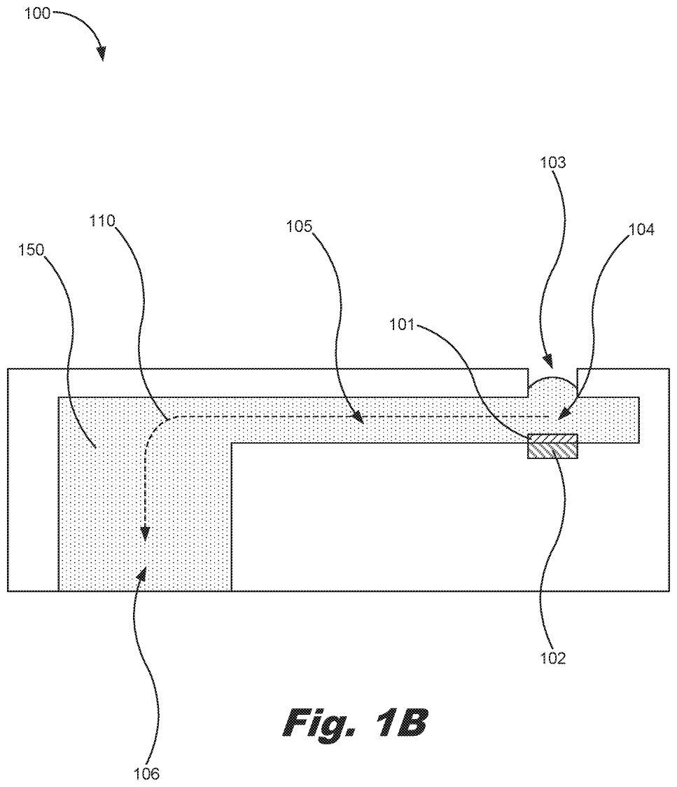

Turning now to the figures, FIG. 1A is a block diagram of a fluid particle concentration detection device (120) including an electrode (101) used in fluid particle concentration detection, according to an example of the principles described herein. The fluid particle concentration detection device (120) may include at least one electrode (101) disposed within a fluidic passageway (130) of a fluidic die (100). The fluid particle concentration detection device (120) may also include control circuitry (160) to activate the electrode (101) within the fluidic die (100). An impedance sensed at the electrode (101) corresponds to a particle concentration within the fluid.

FIG. 1B is a block diagram of a portion of a fluidic die (100) including an electrode (101) used in fluid particle concentration detection, according to an example of the principles described herein. The fluidic die (100) may include a number of passageways, channels, and chambers in which the fluid (150) circulates or moves. In one example, a number of fluid slots (106) may be used to deliver fluid to a number of fluid channels (105) and into a number of fluid ejection chambers (104).

Each of the fluid ejection chambers (104) may include an actuator (102) used to eject a volume of the fluid (150) from the ejection chamber (104), out a nozzle (103), and onto a media, for example. The actuators (102) may be, for example, thermal heating devices used to form a drive bubble of vaporized fluid separated from liquid fluid by a bubble wall. The drive bubble may be used to force the fluid from the fluid ejection chamber (104) and out the nozzle (103). Once the drive bubble collapses, additional fluid from a reservoir may flow into the fluid slots (106), fluid channels (105), and fluid ejection chambers (104), replenishing the lost fluid volume from the creation of the drive bubble and the ejection of the fluid. This process may be repeated each time the fluidic die (100) is instructed to eject fluid. In another example, the actuators (102) may be piezoelectric actuators to generate a pressure pulse that forces a volume of the fluid out of the nozzle (103). In this example, the piezoelectric actuators may include a piezoelectric material that has a polarization orientation that provides a motion into the fluid ejection chambers (104) when and electrical charge is applied to the piezoelectric material.

The fluidic die (100) may also include an electrode (101) used to detect the concentration of particles within the fluid. In one example, the electrode (101) may be placed above the actuator (102) as depicted in FIG. 1B. However, the electrode (101) may be placed anywhere within the fluidic die (100) including, for example, the fluid slots (106), the fluid channels (105), other areas within the fluid ejection chambers (104), other fluidic passageways within the fluidic die (100), or combinations thereof. The electrode (101) is electrically coupled to control circuitry associated with the fluidic die (100) to allow for the control circuitry to actuate the electrode when a particle concentration of the fluid is to be determined.

A current may be applied to the electrode (101) when a fluid particle concentration is to be detected, and a voltage may be measured. Conversely, in another example, a voltage may be applied to the electrode (101) when a fluid particle concentration is to be detected, and a current may be measured. The voltage applied to the electrode (101) may be a non-nucleating and non-drive-bubble-forming pulse. In contrast, when a portion of the fluid (150) is to be ejected from the fluidic die (100), the actuator (102) may be actuated to create a drive bubble as described herein. Thus, a fixed current may be applied to the fluid (150) surrounding the electrode (101), and a resulting voltage at the electrode (101) may be sensed. The sensed voltage may be used to determine an impedance of the fluid (150) surrounding the electrode (101) at that area within the fluidic die (100) at which the electrode (101) is located. Electrical impedance is a measure of the opposition that the circuit formed from the electrode (101) and the fluid (150) presents to a current when a voltage is applied to the electrode (101), and may be represented as follows:

z=V/I Eq. 1

where Z is the impedance in ohms (Ω), V is the voltage applied to the electrode (101), and I is the current applied to the fluid (150) surrounding the electrode (101). In another example, the impedance may be complex in nature, such that there may be a capacitive element to the impedance where the fluid may act partially like a capacitor. A measured capacitance in this example may change with the properties of the fluid such as particle concentration.

The detected impedance (Z) is proportional or corresponds to a particle concentration in the fluid. Stated in another way, the impedance (Z) is proportional or corresponds to a dispersion level of the particles within the fluid vehicle of the fluid. In one example, if the impedance is relatively lower, this indicates that a higher particle concentration exists within the fluid in that area at which the particle concentration is detected. Conversely, if the impedance is relatively higher, this indicates that a lower particle concentration exists within the fluid in that area at which the particle concentration is detected. Lower particle concentration within a portion the fluid may indicate that PVS has occurred, and that remedial measures may be taken to ensure that the particle concentration is made homogeneous throughout all the fluid within the fluidic die (100), homogeneous throughout the fluid in the fluid slots (106), fluid channels (105), fluid ejection chambers (104) or combinations thereof, or homogeneous based on an original or manufactured homogeneity of the fluid.

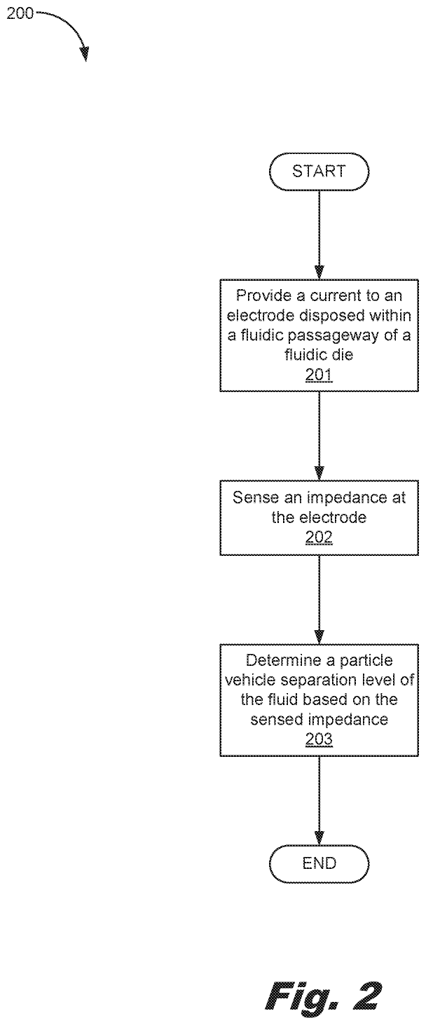

FIG. 2 is a flowchart showing a method (200) of detecting fluid particle concentration, according to an example of the principles described herein. The method of FIG. 2 may begin by providing (block 201) a current to the electrode (101) disposed within a fluidic passageway of the fluidic die (100). An impedance may be sensed (block 202) at the electrode (101), and a particle vehicle separation level may be determined (block 203) within the fluid (150) based on the sensed impedance. As described herein, the sensed current or voltage at the electrode (101) may be converted to an impedance, and the impedance may be used to determine (block 203) the particle vehicle separation level. In this manner, the PVS of the fluid within the fluidic die (100) may be determined based on the impedance value detected by the electrode (101).

In one example, the method of claim 2 may be performed during a quiescent period of the fluidic die (100). In one example, a quiescent period of the fluidic die (100) may include a steady-state (DC) voltage or current at a specified terminal of the fluidic die (100) with no input signal applied. For example, the quiescent period may be a period during when electrical noise sources such as firing currents are quiet or are not present, and when no drive bubble is present in the fluid ejection chambers (104).

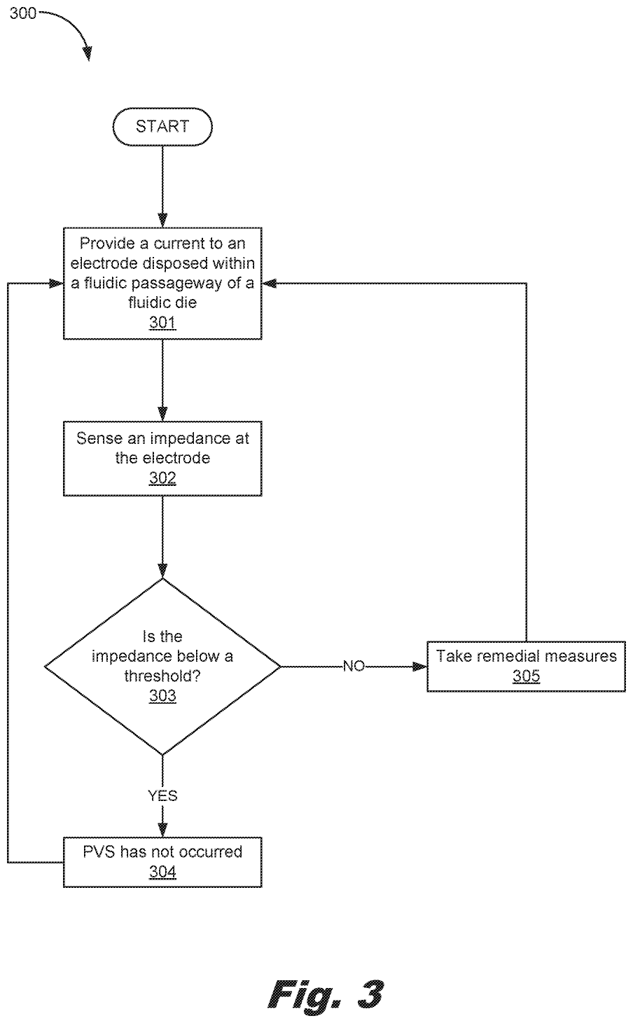

FIG. 3 is a flowchart showing a method (300) of detecting fluid particle concentration, according to another example of the principles described herein. The method of FIG. 3 may begin by providing (block 301) a current to the electrode (101) disposed within a fluidic passageway of the fluidic die (100). A voltage may be sensed (block 302) at the electrode (101).

The sensed voltage may be converted to an impedance, and, at block 303, it may be determined (block 303) whether the impedance is below a threshold. In one example, the threshold may be set based on a desired print quality at various levels of PVS. In other words, the threshold in this example may be based on an impedance level that results in at least a desired print quality or better. In one example, the threshold may be set by an operator of the fluidic die such that the operator may indicate a desired print quality that corresponds to an identified impedance level.

In response to a determination that the impedance is below a threshold (block 303, determination YES), particle vehicle separation (PVS) has not occurred (block 304), or PVS has not occurred to a level at which the print quality of a printed media is decreased. In one example, the method (300) may loop back to block 301 in order to allow for another fluid particle concentration detection instance to occur. This looping allows for any number of fluid particle concentration detection instance to occur. A subsequent instance of fluid particle concentration detection may be a second detection as to the sensor, or may be a detection of fluid particle concentration associated with a different sensor within the fluidic die (100).

In response to a determination that the impedance is not below (i.e., is above) a threshold (block 303, determination NO), particle vehicle separation (PVS) has occurred (block 304), or PVS has occurred to a level at which the print quality of a printed media is decreased, a number of remedial measures may be taken (block 305) to correct the PVS and increase the particle concentration to a homogeneous level. The remedial measures may include, for example, activation of a number of pumps internal and external to the fluidic die (100) to move the particles within the fluid into a homogeneous state, activation of the actuator (102) used to eject a volume of the fluid (150) from the ejection chamber (104) during, or example a spitting operation, other remedial measures, or combinations thereof. In one example, the method (300) may loop back to block 301 in order to allow for another fluid particle concentration detection instance to occur. This looping allows for any number of fluid particle concentration detection instance to occur.

The impedance sensed by the electrode correlates with the particle concentration within the fluid. Although an impedance below the threshold may indicate that PVS has not occurred, and an impedance above the threshold may indicate that PVS has occurred, in some systems and methods, the opposite may be true. For example, in some situations the detected voltage and determined impedance level may be used such that an impedance above the threshold may indicate that PVS has not occurred, and an impedance below the threshold may indicate that PVS has occurred.

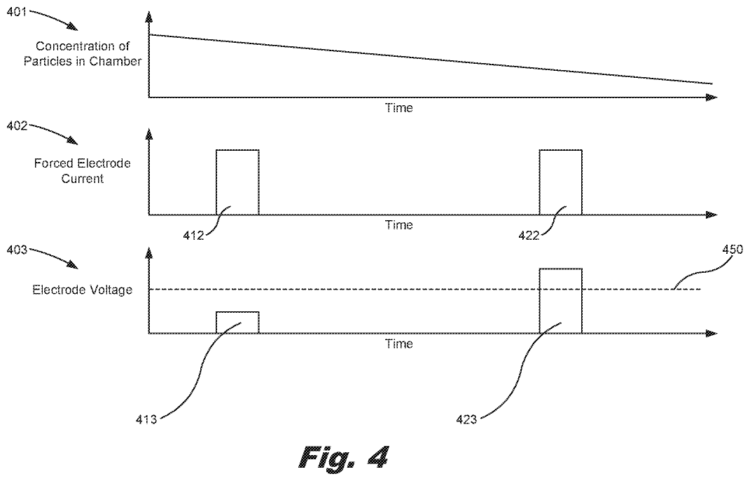

FIG. 4 depicts a number of graphs (401, 402, 403) depicting the concentration of particles, forced electrode current, and electrode voltage over time, according to an example of the principles described herein. In graph (401), the concentration of particles in the fluid vehicle may, over time, be reduced in, for example, the fluid ejection chamber (104) as the particles move to other areas of the fluidic die (100) such as the fluid slots (106) and fluid channels (105). In this state, the fluid vehicle of the fluid may be in higher abundance relative to the particles within the fluid. As the fluid (150) within the fluidic die (100) sits without being moved within or ejected from the fluidic die (100), PVS begins to occur, and the longer the fluidic die (100) remains in this state, the greater the amount of pigments separate from the fluid vehicle.

In graphs 402 and 403, a forced electrode current is depicted as being equal in two separate instances where the forced electrode current (412) is used to detect a PVS level in a first instance, and an identical forced electrode current (422) is used to detect a PVS level in a second instance. In graph 403, during the forced electrode current (412) in the first instance of PVS detection, the electrode voltage (413) detected and the corresponding impedance level is below a PVS detection threshold (450). In this state, it is determined that PVS has not occurred (block 304), or PVS has not occurred to a level at which the print quality of a printed media is decreased. However, during the forced electrode current (422) in the second instance of PVS detection, the electrode voltage (423) detected and the corresponding impedance level is above a PVS detection threshold (450) corresponding to an unacceptable PVS state. In this state, it is determined that PVS has occurred (block 304), or PVS has occurred to a level at which the print quality of a printed media is decreased, and a number of remedial measures may be taken (block 305) to correct the PVS and increase the particle concentration to a homogeneous level. At least one remedial process may be implemented, and the remedial processes may include, for example, a micro-recirculation of the fluid (150) within the passageways of the fluidic die (100), a macro-recirculation of the fluid (150) within the passageways of the fluidic die (100), a spitting operation, an adjustment of a backpressure of the fluid (150) to pull a meniscus of the fluid (150) into the fluidic passageway and a kogating of the fluid (150), a wiping an orifice plate of the fluidic die (100), or combinations thereof.

In one example the profiles of the electrode voltage (413, 423) may have a different shape, magnitude, or combinations thereof. In this example, these types of profiles may be assessed so as to determine particle concentration taking into account the different shape and/or magnitudes of the profiles of the electrode voltage (413, 423).

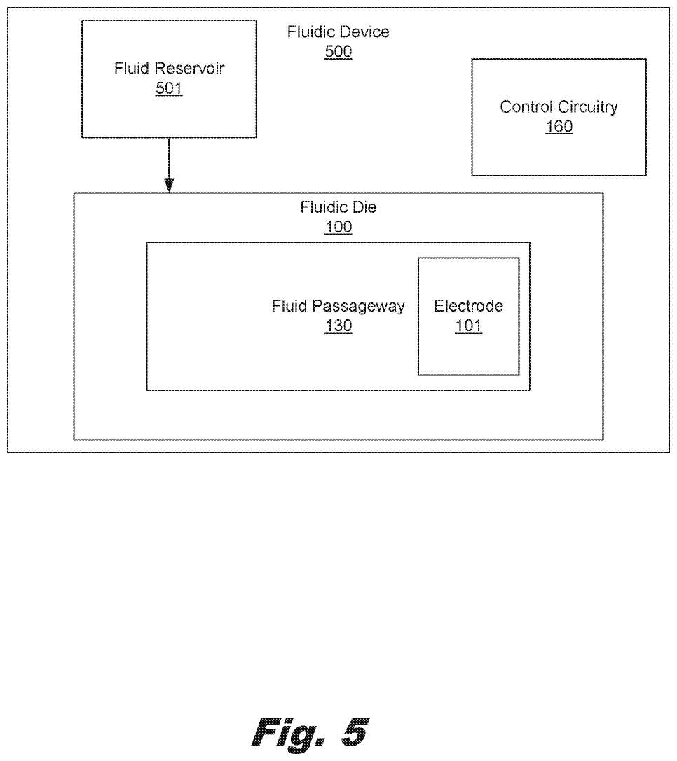

FIG. 5 is a block diagram of a fluidic device (600), according to an example of the principles described herein. The fluidic device (600) may include a fluid reservoir (501) for storing a volume of fluid (150). A fluidic die (100) may be fluidically coupled to the fluid reservoir (150). An electrode (101) may be disposed within a fluidic passageway (130) of the fluidic die (100).

Control circuitry (160) may be included in the fluidic device (600) to activate the electrode (100) within the fluidic die (100). As described herein, an impedance sensed at the electrode (101) is proportional to a dispersion level of a solid within a fluid vehicle of the fluid (150).

The specification and figures describe a fluid particle concentration detection device. The fluid particle concentration detection device may include at least one electrode disposed within a fluidic passageway of a fluidic die, and control circuitry to activate the electrode within the fluidic die. An impedance sensed at the electrode corresponds to a particle concentration within the fluid. A method of detecting fluid particle concentration. may include providing a current to an electrode disposed within a fluidic passageway of a fluidic die, the current being forced into a fluid within the fluidic die, sensing a voltage at the electrode; and determining a fluid particle concentration level of the fluid based on the sensed voltage. The fluid particle concentration level of the fluid may correspond to by an impedance value based on the sensed voltage. The systems and methods described herein detect when PVS has occurred allowing for corrective actions to be taken.

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluid particle concentration detection device, comprising:
at least one electrode disposed within a fluidic passageway of a fluidic die; and
control circuitry to activate the electrode within the fluidic die,
wherein an impedance sensed at the electrode corresponds to a particle concentration within the fluid.

2. The fluid particle concentration detection device of claim 1, wherein the fluidic passageway is a fluid ejection chamber.

3. The fluid particle concentration detection device of claim 1, wherein the fluidic passageway is a fluid channel.

4. The fluid particle concentration detection device of claim 1, wherein the fluidic die is a fluid ejection die.

5. The fluid particle concentration detection device of claim 1, wherein an impedance sensed by the electrode correlates with the particle concentration within the fluid.

6. A fluidic device, comprising:
a fluid reservoir for storing a volume of fluid;
a fluidic die fluidically coupled to the fluid reservoir;
an electrode disposed within a fluidic passageway of the fluidic die; and
control circuitry to activate the electrode within the fluidic die,
wherein an impedance sensed at the electrode is proportional to a dispersion level of a solid within a fluid vehicle of the fluid.

7. The fluidic ejection device of claim 6, wherein the fluidic passageway is a fluid ejection chamber.

8. The fluidic ejection device of claim 6, wherein the fluidic passageway is a fluid channel.

9. The fluidic ejection device of claim 6, wherein:
a relatively lower impedance corresponds to a higher particle concentration within the fluid; and
a relatively higher impedance corresponds to a lower particle concentration within the fluid.

10. A method of detecting fluid particle concentration, comprising:
providing a current to an electrode disposed within a fluidic passageway of a fluidic die, the current being forced into a fluid within the fluidic die;
sensing an impedance at the electrode; and
determining a fluid particle concentration level of the fluid based on the sensed impedance.

11. The method of claim 10, wherein:
a relatively lower impedance corresponds to a higher particle concentration within the fluid; and
a relatively higher impedance corresponds to a lower particle concentration within the fluid.

12. The method of claim 10, comprising:
determining if the fluid particle concentration level is below a threshold; and
in response to a determination that the fluid particle concentration level is below the threshold, performing at least one process to increase the fluid particle concentration level.

13. The method of claim 12, comprising, in response to a determination that the fluid particle concentration level is above the threshold, performing a fluid ejection process.

14. The method of claim 10, wherein the method is performed during a quiescent period of the fluidic die.

15. The method of claim 12, wherein the at least one process comprises a micro-recirculation of the fluid within the fluidic passageway, a macro-recirculation of the fluid within the fluidic passageway, a spitting operation, an adjustment of a backpressure of the fluid to pull a meniscus of the fluid into the fluidic passageway, a wiping an orifice plate of the fluidic die, or combinations thereof.
